(19) United States
(12) Patent Application Publication
(10) Pub. No.: US 2005/0189841 A1
(43) Pub. Date: Sep. 1, 2005

(54) Commutator for an electric machine and method for producing same

(76) Inventor: Joze Potocnik, Idrija (SI)

Correspondence Address: KATTEN MUCHIN ROSENMAN LLP, 575 MADISON AVENUE, NEW YORK, NY, 10022-2585, US

(21) Appl. No.: 11/114,684

(22) Filed: Apr. 25, 2005

Related U.S. Application Data
(63) Continuation of application No. PCT/EP03/11917, filed on Oct. 27, 2003.

(30) Foreign Application Priority Data
Oct. 28, 2002 (DE) 102 50 261.7

(51) Int. Cl. H02K 13/04; H01R 43/10

(52) U.S. Cl. 310/236; 29/597

(57) ABSTRACT

The invention relates to a commutator for an electrical machine, comprising a carrier body produced from a moulding material, and a plurality of metallic conductor segments which are homogeneously arranged on said carrier body about the commutator axis and comprise connecting elements thereon. Said carrier body has two regions which are produced from different moulding materials and are pressed against each other in a positively locking manner, namely a carrier body base and a leakage current screen. The radially outwardly open leakage current screen comprising isolating surfaces charged with a leakage current is arranged between the conductor segments and consists of a first moulding material which is more resistant to leakage current than the second moulding material of the carrier body base.

### CROSS-REFERENCE TO RELATED APPLICATION

This application is a continuation of International Application PCT/EP2003/011917 filed on Oct. 27, 2003, now PCT Publication Number WO 2004/038905, and claims priority from German Application 102 50 261.7 filed on Oct. 28, 2002, the contents of which are herein wholly incorporated by reference.

The present invention relates to a commutator for an electric machine, comprising a support member made from molding compound and a plurality of metal conductor segments disposed thereon in evenly spaced manner around the commutator axis, with terminal elements disposed thereon. The present invention also relates to a method for producing such a commutator.

Commutators of the foregoing type are known in two fundamentally different designs, namely as drum commutators and as flat commutators. Whereas drum commutators are provided with a brush contact face disposed cylindrically around the commutator axis, the brush contact face in flat commutators lies in a plane disposed perpendicular to the commutator axis. In each case the support member, which in drum commutators generally has the form of a sheath, serves to secure the position of the metal conductor segments in their specified arrangement even under varying operating conditions, to insulate the individual conductor segments from one another and to fasten the commutator on the rotor shaft of the electric machine to be equipped therewith, while also ensuring that the conductor segments are insulated from the rotor shaft. As regards these functions, the support member is generally molded from insulating molding compound, usually on the basis of phenol resin, for which purpose the molding compound—which occasionally is also known as compression molding compound or compression molding material—is compression-molded around armature parts of the conductor segments in a suitable mold cavity of an injection-molding die in such a way that each armature part is firmly embedded in the subsequent support member.

During the production of commutators of both designs, individual prefabricated conductor segments or else a conductor blank comprising the conductor segments can be used. In the second case mentioned in the foregoing, the conductor blank is subdivided into the individual conductor segments insulated from one another by cutting or turning after the support member has been injection molded.

Also known are commutators whose support members are not composed, or in any case not exclusively composed of molding compound. For example, European Patent 0325353 and German Patent 19642138 A1 each describe the pre-assembly of the individual conductor segments of a drum commutator on a prefabricated assembly cage made of plastic, which cage is subsequently surrounded by molding compound injected under pressure and in this way becomes a permanent, integral constituent of the commutator. According to German Patent 3714098 A1, the support member comprises a sheath-like hub part, which may be made of metal or insulating material, and a thin-walled insulating shell (flexible tubing, wrapped film or the like). The conductor segments are disposed around this support member and are clamped against the support member by means of reinforcing rings. The intermediate spaces present between the conductor segments can but do not have to be filled subsequently with molding compound.

The large number of design proposals dealing with commutators of the class in question proves the great need for practical commutators of this type. At the same time, it can be inferred from this that numerous groups of problems exist that have not yet been solved to a satisfactory extent.

This is due to the fact among others that different requirements sometimes clash with one another in known commutators of the class in question; they include in particular the objectives of suitable overall dimensions, high efficiency, especially at high current intensities, low manufacturing costs, high reliability and long useful life of the commutator. It is precisely in regard to the two last-mentioned criteria that the configuration of the support member is also important. After all, in commutators whose support members have been produced using standard molding compounds based on phenol resin, the efficiency, reliability and useful life of the commutator suffer in the same way from charring, which favors the occurrence of leakage currents, especially of the exposed surface of the support member between the conductor segments in the region of the air insulation gaps. On the other hand, even commutators whose support members were manufactured from relatively leakage-current-resistant molding compound have only an unsatisfactory useful life, because in this case the support member has only relatively small dimensional stability, meaning that the brush contact face can become out-of-round in drum commutators (edge mismatch of bars, eccentricity, etc.) or uneven in flat commutators during operation, especially at high temperatures.

The object of the present invention is to provide a commutator of the type specified hereinabove, which commutator can be produced relatively inexpensively and which simultaneously exhibits high efficiency, especially at high current intensities, while nevertheless achieving high reliability and long useful life.

The object specified in the foregoing is achieved according to the present invention in that the support member is provided with two regions made from different molding compounds and pressed interlockingly against one another, namely a support-member base and an anti-leakage-current lining, wherein the anti-leakage-current lining, which is open in radially outward direction and is provided with insulating surfaces exposed to leakage current, is disposed between the conductor segments and is composed of a first molding compound that is more resistant to leakage current than the second molding compound of the support-member base. According to the present invention, therefore, it is essential in particular that the support member be composed of two different molding compounds that have different material characteristics, wherein the anti-leakage-current linings disposed between the conductor segments, each of which linings is open in radially outward direction and has insulating surfaces exposed to leakage current, have higher leakage-current resistance than the remaining molding-compound region forming the support-member base. A particular advantage of the commutator structured according to the present invention lies in its particularly high efficiency in combination with high reliability, without incurring unjustified manufacturing costs to achieve these qualities. After all, by use of the present invention, it is possible to produce commutators whose support members are extremely dimensionally stable, so that no noteworthy out-of-round or unevenness of the brush contact face develops even under extreme operating conditions, while at the same time the danger of loss of efficiency or of failure of the commutator due to leakage currents is minimized. In this connection, it has proved particularly favorable that all three surfaces that in commutators of conventional design are susceptible to leakage-current development, namely the insulation surfaces between each two conductor segments, are in the case of inventive commutators protected effectively from charring in the region of the lacquer barrier adjacent to the terminal elements and also in the region of the front side disposed opposite the terminal elements.

Although the present invention is suitable in a special way for implementation in drum commutators, it is not limited thereto. To the contrary, the invention can in principle also be employed in the same way for flat commutators. Thus any reference made hereinafter to drum commutators for the purpose of explaining the invention is not to be construed as restricting the invention to commutators of that design.

According to a first preferred improvement of the invention, it is provided that the molding compound of the leakage-current lining be based on polyester, melamine-formaldehyde, epoxy, allyl ester or another leakage-current-resistant resin, on a combination of several of those resins or on a combination of at least one of those resins with phenol resin. In this case the leakage-current resistance on the endangered surfaces of the support member is expected to be approximately twice as high as that achieved by standard production of the entire support member from phenol resin. By comparison, the support-member base has better mechanical characteristics, especially higher thermal resistance and dimensional stability than the anti-leakage-current lining; it is composed particularly preferably of a molding compound based on phenol resin or containing phenol resin. In order to optimize the practical characteristics of the inventive commutator in the sense explained hereinabove, it is sufficient for the anti-leakage-current lining to have a relatively small radial layer thickness, compared with the value of between 0.5 and 3 mm, for example, in commutators of standard dimensions.

According to another preferred improvement of the invention, it is provided that the largest width of the individual regions of the anti-leakage-current lining measured in circumferential direction be larger than the width of the air-insulation gaps present between each two adjacent conductor segments. In this connection, the width of the individual regions of the anti-leakage-current lining in particular can increase from outside to inside in radial direction, in which case that of the individual regions of the anti-leakage-current lining is disposed interlockingly against each of the two adjacent conductor segments over its entire layer thickness. This configuration is favorable as regards dimensional stability and secure adhesion of the anti-leakage-current lining and thus as regards the useful life of the inventive commutator. This is true in particular when, in a further preferred improvement of the invention, the conductor segments are provided with radially inwardly directed armature parts, which are anchored both in the anti-leakage-current lining and in the support-member base.

Yet another preferred improvement of the invention is characterized in that the anti-leakage-current lining is provided with outwardly directed grooves, which extend over part of the thickness, are aligned with the respective associated air-insulation gap and prolong this radially inward. Such improved commutators are characterized by a particularly low risk of suffering damage due to leakage currents.

According to yet another preferred improvement of the invention, it is provided that the anti-leakage-current lining and the support-member base each lie against one another along common boundary faces. Each of these boundary faces can have uneven relief structure, so that the anti-leakage-current lining and the support-member base engage interlockingly with one another. On the other hand, the boundary surfaces can also have an even finish. In this connection, what is of considerable importance is the method by which the inventive commutator is produced. This will be explained in greater detail hereinafter.

In inventive commutators, each of the radially outwardly directed insulation surfaces of the individual regions of the anti-leakage-current lining can be provided, especially adjacent to the terminal elements, with a nose that is directed outwardly, toward the brush contact face.

A particularly preferred method for producing commutators according to the present invention comprises the following steps: loading metal conductor segments into a die; filling of first, relatively leakage-current-resistant molding compound into intermediate spaces present between each two adjacent conductor segments, which spaces are bounded radially inwardly by a rib of a first inner die; removing the first inner die; insertion of a second inner die, which defines the contour of the support member to be molded; injecting second, relatively heat-resistant and dimensionally stable molding compound into the die under pressure, in the course of which the two molding compounds are cross-linked and cured by pressure and heat of the second molding compound. A particularly favorable feature of this method is that only a single compression-molding operation is necessary for the molding compound, since the first molding compound can be filled into the intermediate spaces defined hereinabove without application of pressure; accordingly, only a single mold suitable for compression molding of the support member is needed. In this connection, the first molding compound preferably has pasty consistency while being filled in, so that on the one hand it does not flow out of the die after removal of the first inner die and on the other hand, however, it can be deformed by the second molding compound as it is being injected into the mold under pressure. In this connection, it proves to be particularly favorable for the first molding compound to be based on thermosetting plastics that have not yet cured by the time when the second molding compound is being injected under pressure, so that the first molding compound is deformed into interlocking contact along the conductor segments during compression molding of the second molding compound. In particular, this first molding compound can be based on polyester, melamine-formaldehyde, epoxy, allyl esters or other leakage-current-resistant resins or on a combination of those resins.

During the production process explained hereinabove, the conductor segments can initially be part of a one-piece conductor blank and be separated from one another only after the support member has been removed from the mold, for example by saw cuts or by turning off the bridging parts joining the individual conductor segments to one another. In this case, the intermediate spaces into which the first molding compound used to form the anti-leakage-current lining is filled can be bounded radially outwardly by the bridging parts of the conductor blank. In the same way, however, the production process explained hereinabove can be achieved even by using individually prefabricated conductor segments, which are inserted in a manner known in itself into an assembly cage. In this case, it is particularly favorable for the said intermediate spaces to be bounded radially outwardly by spacer strips, which are part of the assembly cage.

An alternative method for producing a commutator according to the present invention comprises the following steps: loading metal conductor segments into a first die; injecting one of the two molding compounds into an associated cavity of the first die under pressure; allowing the compression-molded molding compound to cure; removing the intermediate product comprising the conductor segments and the cured molding compound from the first die and loading this intermediate product into a second die; injecting the other molding compound into an associated cavity of the second die under pressure; allowing the molding compound injected under pressure in the second compression-molding step to cure. A characteristic advantage of this production method is that first leakage-current-resistant molding compounds that are relatively fluid at the time when they are being processed can also be used; furthermore, and this is not easily possible in the version of the method described hereinabove, leakage-current-resistant thermoplastic molding compounds can also be used to produce the anti-leakage-current lining. On the other hand, since the two molding compounds forming the support member are compression-molded separately from one another, two correspondingly suitable molds are needed.

Merely for completeness, it is to be pointed out that the present invention can be used in the same way for commutators with reinforcing rings and for commutators without reinforcing rings. However, the circumstance that the explanation given hereinafter of preferred practical examples of the invention relates only to commutators without reinforcing rings is not to be construed as restricting the invention thereto.

The present invention will be explained in more detail hereinafter with reference to two preferred practical examples, each relating to a drum commutator and illustrated in the drawing, wherein

FIG. 1 shows an axial section through a first embodiment of a drum commutator constructed according to the present invention,

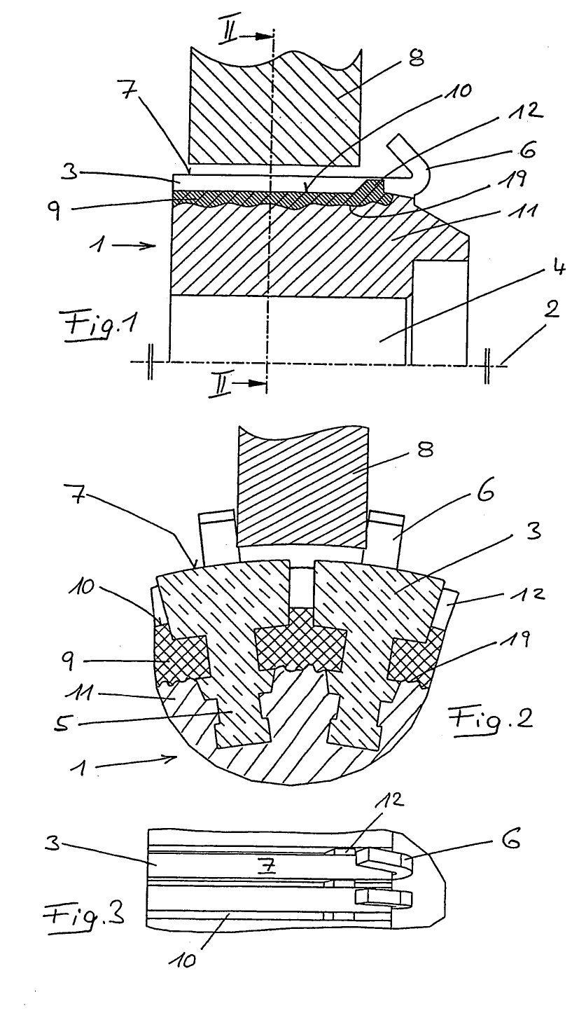

FIG. 2 shows an enlarged cross section through the drum commutator according to FIG. 1, along line 11-11,

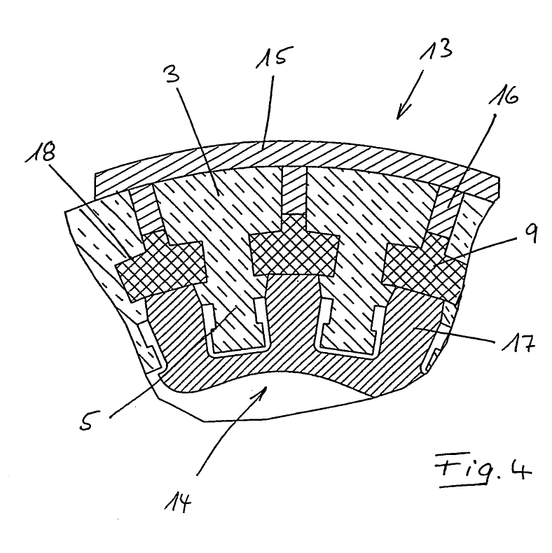

FIG. 3 shows the detail of a side view of the drum commutator according to FIGS. 1 and 2,

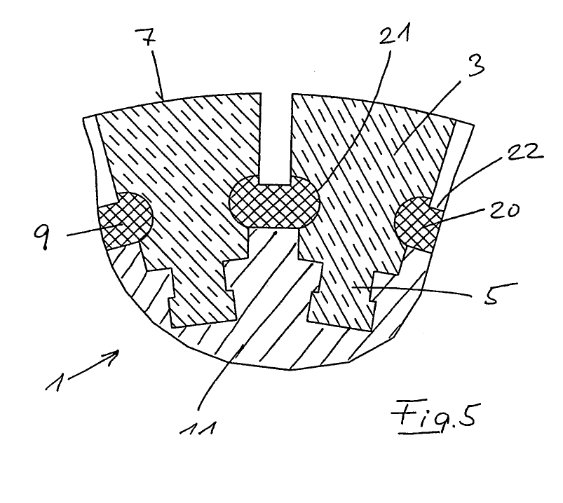

FIG. 4 shows a cross section through a die used to produce the drum commutator according to FIGS. 1 to 3 during an intermediate step of production of the corresponding drum commutator, and

FIG. 5 shows a cross section through a second embodiment of a drum commutator constructed according to the present invention.

The drum commutator illustrated in FIGS. 1 to 3 of the drawing contains as essential components a support member 1 made of molding compound and conductor segments 3, which are disposed evenly around commutator axis 2. An air-insulation gap is present between each two adjacent conductor segments 3. Support member 1 is provided with a bore 4 concentric with axis 2 in order to mount the commutator on a rotor shaft.

Armature parts 5 disposed radially inwardly on conductor segments 3 are embedded in the molding compound of support member 1 in order to anchor the conductor segments securely even at high speeds, despite the centripetal forces then occurring. At the ends of conductor segments 3 there are provided terminal elements in the form of terminal lugs 6, which function in a manner known as such as the terminals of winding wires on the commutator. Obviously the terminal elements could also be configured in some other suitable manner, such as in the form of slits or as a soldered crown, instead of being configured as terminal lugs. The radial outer faces 7 of conductor segments 3 are disposed on a cylindrical surface and form the contact face for brushes 8.

In the scope of the foregoing explanations, the commutator illustrated in FIGS. 1 to 3 of the drawing corresponds to the long-known prior art, and so further explanations are not needed.

Support member 1 is composed of two different molding compounds, which have different material characteristics; it includes an anti-leakage-current lining 9, whose individual regions are each provided with a radially outwardly open insulation surface 10 disposed between conductor segments 3, and a support-member base 11, which occupies the remaining part of support member 1. According to the present invention, anti-leakage-current lining 9, which has only relatively small radial thickness, has greater leakage-current resistance than support-member base 11. In the illustrated practical example, this is achieved by the fact that support-member base 11 is composed of a molding compound containing a phenol resin, whereas anti-leakage-current lining 9 is composed of a molding compound containing polyester resin, melamine resin and/or epoxy resin. In such a material pair, support-member base 11 has better mechanical characteristics, especially higher thermal resistance, than does anti-leakage-current lining 9.

The radially inwardly directed armature parts 5 of conductor segments 3 are anchored both in anti-leakage-current lining 9 and in support-member base 11, by being appropriately embedded in the respective molding compound.

Radially outwardly directed insulation surfaces 10 of anti-leakage-current lining 9 are offset inwardly relative to the brush contact face and are each provided adjacent to terminal lugs 6 with an outwardly directed nose 12.

FIG. 4 illustrates that step of the method during production of the drum commutator illustrated in FIGS. 1 to 3 in which formation of anti-leakage-current lining 9 composed of relatively leakage-current-resistant molding compound begins. For this purpose there is used a multi-part die, which comprises an outer die 13 and a first inner die 14. Outer die 13 in turn comprises a shell 15, on the inside face of which there bear spacer strips 16 of an assembly cage. These strips control the distance between each pair of adjacent conductor segments 3, and thus define the dimensions of the subsequent air-insulation gaps of the drum commutator. First inner die 14 comprises radially outwardly directed ribs 17. These each bear with lateral sealing faces against armature parts 5 of two mutually adjacent conductor segments 3. In this way respective intermediate spaces 18, which can be filled with first leakage-current-resistant molding compound to form respective individual regions of anti-leakage-current lining 9, as illustrated in FIG. 4, are defined by two mutually adjacent conductor segments 3, a spacer strip 16 disposed between them and a rib 17 also disposed between conductor segments 3 in question.

After first inner die 14 has been removed, there is introduced a second inner die—not illustrated—which via an appropriate mold cavity defines the contour of the support member to be fabricated. Into each mold cavity there is injected under pressure the quantity of relatively dimensionally stable molding compound necessary to form support-member base 11, whereupon the first molding compound conforms interlockingly and firmly to the associated conductor segments 3 under the corresponding pressure and temperature. As is illustrated in FIGS. 1 and 2, an uneven boundary face 19 with relief structure is then formed between support-member base 11 and anti-leakage-current lining 9, at which the two molding compounds engage interlockingly with one another. By virtue of the heat supplied by the second molding compound, the first molding compound also becomes cross-linked and cured.

FIG. 5 illustrates the production of an inventive drum commutator (having different structural details) by application of an alternative production method. In a first manufacturing step, support-member base 11 is produced using a first die, in such a way that a dimensionally stable molding compound is injected under pressure into the corresponding mold cavity of the first die. After support-member base 11 made in this way has cured, the intermediate product is loaded into a second die, in which the individual regions 20 of leakage-current lining 9 are formed by injection of the second, leakage-current resistant molding compound into a corresponding mold cavity, thus completing formation of support member 1. Individual regions 20 of anti-leakage-current lining 9 engage on both sides in corresponding recesses 21 of conductor segments 3. In the region of their insulation surface 10, individual regions 20 of anti-leakage-current lining 9 are each provided with a groove 22, which is aligned with the respective associated air-insulation gap and prolongs it radially inwardly.

Within the scope of the invention, it is obviously also possible to arrange for the two manufacturing steps in the procedure explained hereinabove to be performed in inverse sequence.

Merely for clarification it is to be added that the commutator illustrated in FIG. 5 obviously can also be produced by using the first alternative method, and likewise that the second alternative method is suitable for production of the commutator according to FIGS. 1 to 3—possibly aside from the specific shape of boundary face 19.

1. A drum commutator for an electric machine, comprising a sheath-like support member made from molding compound and a plurality of metal conductor segments disposed thereon in evenly spaced manner around the commutator axis, with terminal lugs disposed thereon at the ends,
characterized in that
the support member is composed of two different molding compounds, which have different material characteristics, wherein first molding-compound regions, which are disposed between the conductor segments and respectively have a radially outwardly open insulation surface exposed to leakage current, have higher leakage-current resistance than the remaining, second molding-compound region.

2. A drum commutator according to claim 1,
characterized in that
the molding compound of the first molding compound regions is based on polyester, melamine-formaldehyde, epoxy, allyl ester or other leakage-current-resistant resins or on combinations of these resins.

3. A drum commutator according to claim 1,
characterized in that
the second molding-compound region has better mechanical characteristics, especially higher thermal resistance, than the first molding-compound regions.

4. A drum commutator according to claim 1,
characterized in that
the second molding compound region is composed of a molding compound containing phenol resin.

5. A drum commutator according to claim 1,
characterized in that
the largest width of the first molding-compound regions measured in circumferential direction is larger than the width of the air-insulation gaps present between each two adjacent conductor segments.

6. A drum commutator according to claim 5,
characterized in that
the width of the first molding-compound regions increases from outside to inside in radial direction, the first molding-compound regions being disposed interlockingly against the two adjacent conductor segments over their entire layer thickness.

7. A drum commutator according to claim 5,
characterized in that
the first molding-compound regions are each provided with an outwardly directed groove, which extends over part of the thickness, is aligned with the respective associated air-insulation gap and prolongs this radially inward.

8. A drum commutator according to claim 1,
characterized in that
the first molding-compound regions and the second molding-compound region each lie against one another along common boundary faces.

9. A drum commutator according to claim 8,
characterized in that
the boundary faces have uneven relief structure, so that the first molding-compound regions and the second molding-compound region engage interlockingly with one another.

10. A drum commutator according to claim 8,
characterized in that
the boundary surfaces are even.

11. A drum commutator according to claim 1, characterized in that
the conductor segments are provided with radially inwardly directed armature parts, which are anchored both in the first molding-compound regions and in the second molding-compound region.

12. A drum commutator according to claim 1, characterized in that
the radially outwardly directed insulation surfaces of the first molding-compound regions are each provided adjacent to the terminal lugs with an outwardly directed nose.

13. A method for production of a drum commutator according to claim 1, comprising the following steps:
loading prefabricated metal conductor segments into a die, wherein spacer strips of an outer die define the subsequent air-insulation gaps;
filling of first, relatively leakage-current-resistant molding compound into intermediate spaces present between each two adjacent conductor segments, which spaces are bounded radially outwardly by a spacer strip and radially inwardly by a rib of a first inner die;
removing the first inner die;
inserting a second inner die, which defines the contour of the support member to be molded;
injecting second, relatively heat-resistant and dimensionally stable molding compound into the die under pressure, in the course of which the two molding compounds are cross-linked and cured by pressure and heat of the second molding compound.

14. A method according to claim 13,
characterized in that
the first molding compound is based on thermosetting plastics that have not yet cured by the time when the second molding compound is being injected under pressure, so that the first molding compound is deformed during compression molding of the second molding compound.

15. A method according to claim 13,
characterized in that
the first molding compound is based on polyester, melamine-formaldehyde, epoxy, allyl esters or other leakage-current-resistant resins or on a combination of those resins.

16. A method for production of a drum commutator according to claim 1, comprising the following steps:
loading prefabricated metal conductor segments into a first die;
injecting one of the two molding compounds into an associated cavity of the first die under pressure;
allowing the molding compound that was previously injected under pressure to cure;
removing the intermediate product comprising the conductor segments and the cured molding compound from the first die and loading this intermediate product into a second die;
injecting the other molding compound into an associated cavity of the second die under pressure;
allowing the molding compound that was previously injected under pressure in the second compression-molding step to cure.

17. A method for production of a drum commutator according to claim 1, comprising the following steps:
loading prefabricated metal conductor segments and first molding-compound members disposed respectively between these and also prefabricated into a first die, wherein the first molding-compound members are composed of a first, relatively leakage-current-resistant molding compound;
injecting second relatively thermally resistant and dimensionally stable molding compound into the die under pressure in order to form the second molding-compound region;
allowing the second molding compound that was previously injected under pressure to cure;
removing the commutator from the die.
